(19) United States
(12) Patent Application Publication
(10) Pub. No.: US 2010/0265565 A1
(43) Pub. Date: Oct. 21, 2010

(54) Display Device with Improved Display Performance

(76) Inventors: Tzu-Ming WANG, Hsinchu (TW); Lee-Tyng CHEN, Hsinchu (TW); Ted-Hong SHINN, Hsinchu (TW)

Correspondence Address: LanWay IPR Services, P.O. Box 220746, Chantilly, VA, 20153, US

(21) Appl. No.: 12/463,288

(22) Filed: May 8, 2009

(30) Foreign Application Priority Data
Apr. 20, 2009 (TW) 098113049

(51) Int. Cl. G02F 1/167; G02F 1/01

(52) U.S. Cl. 359/296; 359/290

(57) ABSTRACT

A display device includes a first substrate, a second substrate, a plurality of display units and a plurality of partitioning walls. The second substrate is disposed above the first substrate. The display units are disposed between the first substrate and the second substrate, and each of the display units has a dielectric solvent. The partitioning walls are disposed between adjacent display units correspondingly, and a dielectric coefficient of each of the partitioning walls is less than that of the dielectric solvent adjacent thereto. Because the dielectric coefficient of the partition walls is less than that of the dielectric solvent adjacent to the partition wall, a capacitance value induced at the partition wall by a driving voltage can be decreased. Thus, crosstalk phenomena can be avoided in the display unit that is not driven.

### BACKGROUND

This application claims priority to a Taiwan application No. 098113049 filed Apr. 20, 2009.

### FIELD OF THE INVENTION

The present invention relates to a display device, and more particularly to a display device with improved display performance.

### DESCRIPTION OF THE RELATED ART

In these days, with the development of science and technology, display devices have been used more and more widely in various electronic products. Furthermore, with light, thin, short, small and portable trend of development of the electronic products, some flexible displays devices that are thin in thickness and flexible appear in the market, such as, a microcup electrophoretic display (EPD) device, a quick response-liquid powder display (QR-LPD) device and an electro-wetting display (EWD) device.

Take the microcup electrophoretic display device for example, which includes a plurality of microcup display units. Each of the microcup display units includes a solvent and a plurality of charged particles dispersed in the solvent. When the microcup electrophoretic display device is driven, a driving voltage that is applied may not only provide an electric field to the microcup display units that are required to drive, but also influence the microcup display units that are not required to drive and adjacent to the microcup display units that are required to drive. As such, the charged particles of the microcup display units that are not required to drive would move improperly. That is crosstalk phenomena. Consequently, grey scale is prone to changing improperly and images are prone to distortion, and thus display performance of the microcup electrophoretic display device may be degraded.

To avoid occurring the crosstalk phenomena between the microcup display units, generally, a distance between adjacent microcup display units should be increased, or a driving threshold voltage should be upgraded. However, a resolution of the microcup electrophoretic display device would be degraded with increasing the distance between adjacent microcup display units. In addition, a response speed of the microcup electrophoretic display device would be lowered with upgrading the driving threshold voltage.

Therefore, a new display device is desired in order to overcome the above-described shortcomings.

### BRIEF SUMMARY

The present invention relates to display device that can avoid occurring crosstalk phenomena and improve display performance without influencing a resolution and a response speed.

The present invention provides a display device, which includes a first substrate, a second substrate, a plurality of display units and a plurality of partitioning walls. The second substrate is disposed above the first substrate. The display units are disposed between the first substrate and the second substrate, and each of the display units has a dielectric solvent. The partitioning walls are disposed between adjacent display units correspondingly, and a dielectric coefficient of each of the partitioning walls is less than that of the dielectric solvent adjacent thereto.

In the display device of the present invention, because the dielectric coefficient of the partition walls is less than that of the dielectric solvent, when the predetermined display units are driven, the capacitance value induced at the partition walls by the driving voltage can be decreased. Thus, the crosstalk phenomena can be avoided in the display units that are not driven. As such, the display performance of the display device can be improved without influencing the resolution and the response speed.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic cross-sectional view of a display device according to an exemplary embodiment of the present invention.

FIG. 2 is a schematic view of the display device of FIG. 1, showing a portion of display units being driven.

FIG. 3 is a schematic cross-sectional view of a display device according to another exemplary embodiment of the present invention.

### DETAILED DESCRIPTION

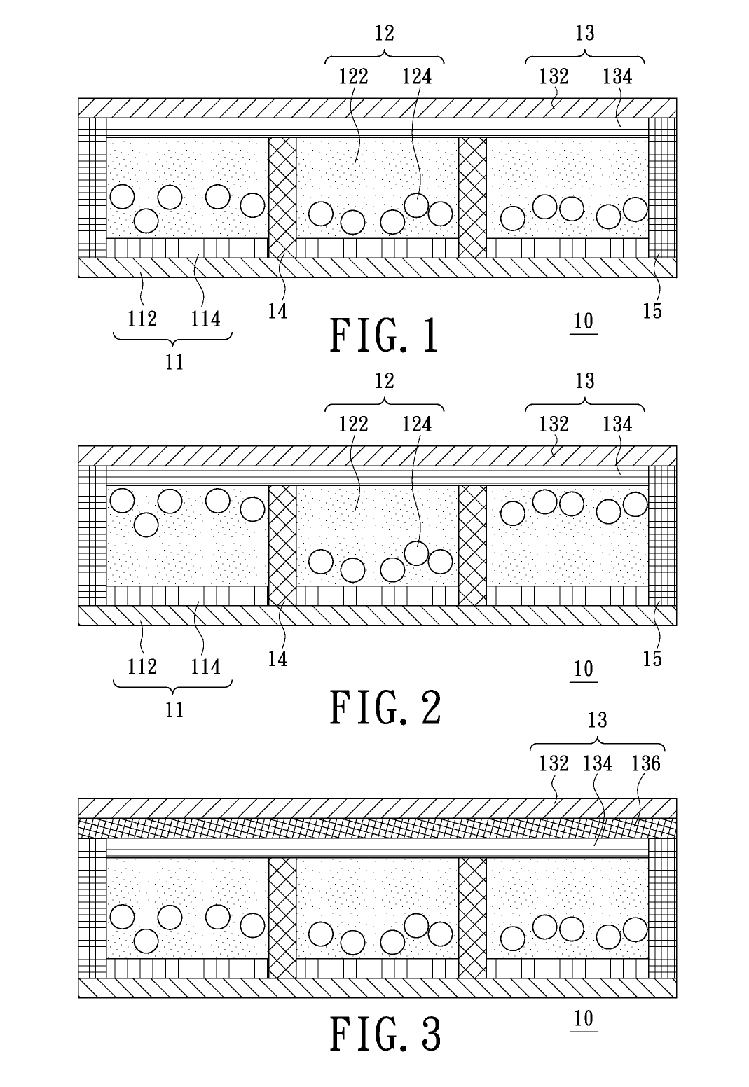

FIG. 1 is a schematic cross-sectional view of a display device according to an exemplary embodiment of the present invention. Referring to FIG. 1, the display device 10 is a microcup electrophoretic display (EPD) device for exemplary purposes, but may be other display devices, such as a quick response-liquid powder display (QR-LPD) device and an electro-wetting display (EWD) device. The display device 10 includes a first substrate 11, a plurality of display units 12, a second substrate 13 and a plurality of partitioning walls 14. The second substrate 13 is disposed above the first substrate 11. The display units 12 are disposed between the first substrate 11 and the second substrate 13, and each of the display units 12 has a dielectric solvent 122. The partitioning walls 14 are disposed between adjacent display units 12 correspondingly, and a dielectric coefficient of each of the partitioning walls 14 is less than that of the dielectric solvent 122 adjacent thereto.

In a described embodiment, the first substrate 11 includes a base 112 and a driving array 114 disposed on the base 112 and located between the base 112 and the display units 12. The driving array 114 can be active or passive. For example, the driving array 114 includes thin film transistors array (TFTs array) and pixel electrodes. Material of the base 112 can be selected from the group consisting of glass, polyimide (PI), polyethylene terephthalate (PET), polyethylene naphthalene (PEN), polymethyl methacrylate (PMMA) and any suitable combination thereof. In a described embodiment, the second substrate 13 includes a transparent plate 132 and a transparent electrode 134. The transparent plate 132 is disposed above the display units 12. The transparent electrode 134 is disposed between the display units 12 and the transparent plate 132. Material of the transparent plate 132 can be selected from the group consisting of glass, polyimide (PI), polyethylene terephthalate (PET), polyethylene naphthalene (PEN), polymethyl methacrylate (PMMA) and any suitable combination thereof. Material of the transparent electrode 134 can be selected from the group consisting of indium tin oxide (ITO), indium zinc oxide (IZO), zinc oxide (ZnO), indium gallium zinc oxide (IGZO) and any suitable combination thereof.

The display units 12 is located between the driving array 114 and the transparent electrode 134, and each of the display units 12 can include a plurality of charged particles 124 dispersed in the dielectric solvent 122. When the display units 12 are driven by applying a driving voltage on the driving array 114 and the transparent electrode 134, the charged particles 124 can move toward the driving array 114 or the transparent electrode 134 according to electric property of the charged particles 124, and as such, a brightness of light that passes through the display units 12 can be controlled.

The partitioning walls 14 is used to space adjacent display units 12, and the dielectric coefficient of the partitioning walls 14 is less than that of the dielectric solvent 122. Referring to FIG. 2, because a capacitance value is inversely proportional to a dielectric coefficient of a medium where an electric field is, when the driving voltage is applied on the driving array 114 and the transparent electrode 134 to drive the display unit 12 located on two sides, the capacitance value induced at the partition walls 14 can be relatively low in comparison with the conventional art, therefore a central display unit 12 that is not driven can avoid occurring crosstalk phenomena. And thus display performance of the display device 10 can be improved without influencing a resolution and a response speed. In this embodiment, the partitioning walls 14 can be made of a liquid or a solid. For example, the partitioning walls 14 are made of material including fluorin, porous material or polymer. Particularly, to further improve shielding effectiveness of the partitioning walls 14, the dielectric coefficient of the partitioning walls 14 can be less than a half of that of the dielectric solvent 122. For example, the dielectric coefficient of the partitioning walls 14 is less than 4.

In addition, referring to FIG. 1 again, the display device 10 can further include a sealant 15 located between the first substrate 11 and the second substrate 13 and formed around the display units 12. The sealant 15 is used to seal the display units 12 between the first substrate 11 and the second substrate 13. Furthermore, to make the display device 10 be a color display device, the second substrate 13 can further includes a color filter 136 disposed between the transparent plate 132 and the transparent electrode 134, as shown in FIG. 3.

In summary, in the display device of the present invention, because the dielectric coefficient of the partition walls is less than that of the dielectric solvent, when the predetermined display units are driven, the capacitance value induced at the partition walls by the driving voltage can be decreased. Thus, the crosstalk phenomena can be avoided in the display units that are not driven. As such, the display performance of the display device can be improved without influencing the resolution and the response speed.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A display device, comprising:
a first substrate;
a second substrate disposed above the first substrate;
a plurality of display units disposed between the first substrate and the second substrate, each of the display units having a dielectric solvent; and
a plurality of partitioning walls disposed between adjacent display units correspondingly, wherein a dielectric coefficient of each of the partitioning walls is less than that of the dielectric solvent adjacent thereto.

2. The display device as claimed in claim 1, wherein the partitioning walls are made of liquid or a solid.

3. The display device as claimed in claim 1, wherein the partitioning walls are made of material including fluorin, porous material or polymer.

4. The display device as claimed in claim 1, wherein the dielectric coefficient of each of the partitioning walls is less than 4.

5. The display device as claimed in claim 1, wherein the dielectric coefficient of each of the partitioning walls is less than a half of that of the dielectric solvent adjacent thereto.

6. The display device as claimed in claim 1, wherein the first substrate comprises:
a base; and
a driving array disposed on the base and located between the base and the display units.

7. The display device as claimed in claim 6, wherein material of the base is selected from the group consisting of glass, polyimide, polyethylene terephthalate, polyethylene naphthalene, polymethyl methacrylate and any combination thereof.

8. The display device as claimed in claim 1, wherein the second substrate comprises:
a transparent plate disposed above the display units; and
a transparent electrode disposed between the display units and the transparent plate.

9. The display device as claimed in claim 8, wherein the second substrate further comprises a color filter disposed between the transparent plate and the transparent electrode.

10. The display device as claimed in claim 8, wherein material of the transparent electrode is selected from the group consisting of indium tin oxide, indium zinc oxide, zinc oxide, indium gallium zinc oxide and any combination thereof.

11. The display device as claimed in claim 8, wherein material of the transparent plate is selected from the group consisting of glass, polyimide, polyethylene terephthalate, polyethylene naphthalene, polymethyl methacrylate and any combination thereof.

12. The display device as claimed in claim 1, wherein the display device is one of a microcup electrophoretic display device, a quick response-liquid powder display device and an electro-wetting display device.

13. The display device as claimed in claim 1, wherein each of the display units comprises a plurality of charged particles dispersed in the dielectric solvent.
